(19) United States
(12) Patent Application Publication
(10) Pub. No.: US 2017/0060116 A1
(43) Pub. Date: Mar. 2, 2017

(54) MACHINING ABNORMALITY AVOIDING SYSTEM AND MACHINING PATH MODIFICATION METHOD THEREOF

(71) Applicant: INDUSTRIAL TECHNOLOGY RESEARCH INSTITUTE, Hsinchu (TW)

(72) Inventors: Shu-Chung LIAO, Taichung City (TW); Ta-Jen PENG, Taichung City (TW); Chin-Te LIN, Erlun Township (TW); Ci-Rong HUANG, Taoyuan City (TW)

(73) Assignee: INDUSTRIAL TECHNOLOGY RESEARCH INSTITUTE, Hsinchu (TW)

(21) Appl. No.: 14/963,227

(22) Filed: Dec. 8, 2015

(30) Foreign Application Priority Data
Aug. 31, 2015 (TW) 104128624

(51) Int. Cl. G05B 19/402

(52) U.S. Cl. CPC G05B 19/402; G05B 2219/50058

(57) ABSTRACT

A machining path modification method includes the following steps: analyzing the machining path of a machining program to decide whether any point of the machining path is an avoidant point; obtaining an abnormal point of the machining path; and if the abnormal point exists, modifying the machining program to add an abnormality avoidant path on the avoidant point of the machining path.

This application claims the benefit of Taiwan application Serial No. 104128624, filed Aug. 31, 2015, the disclosure of which is incorporated by reference herein in its entirety.

### TECHNICAL FIELD

The disclosure relates in general to an abnormality avoidant system and a path modification method thereof, and more particularly to a machining abnormality avoidant system and a machining path modification method thereof.

### BACKGROUND

During the machine tool machining process, machining abnormality, such as chatter, may easily occur due to cutter rotation speed, workpiece size and machining path. Chatter makes the cutter vibrate and deteriorate the machining precision on the surface of the workpiece.

In general, the machine tool can be equipped with sensors to obtain various types of information during the machining process and can predetermine strategies in advance to tackle with the occurrence of abnormality. When abnormality is detected, the control program of the machine tool will automatically investigate according to the predetermined strategies. For example, the machine tool can adjust a machining parameter by increasing the cutter rotation speed or reducing the cutting depth during the machining process.

During the machining process, if the cutter abruptly changes the machining conditions, the cutter will generate obvious traces on the surface of the workpiece because sudden change in cutting condition during the machining process will cause abrupt change to the cutting force and make the cutter damaged or broken.

Therefore, it has become a prominent task for the industries to provide machining abnormality avoiding technology.

### SUMMARY

According to one embodiment, a machining abnormality avoidant system is provided. The machining abnormality avoidant system includes a machining program analyzing module, a machining path analyzing module, an abnormal point obtaining module and a machining program modifying module. The machining program analyzing module is configured to analyze a machining path of a machining program. The machining path analyzing module is configured to analyze whether any point of the machining path is an avoidant point. The abnormal point obtaining module is configured to obtain an abnormal point of the machining path. If the machining path has an abnormal point, the machining program modifying module adds an abnormality avoidant path on the avoidant point of the machining path.

According to another embodiment, a machining path modification method including following steps is provided. A machining path of a machining program is analyzed. Whether any point of the machining path is an avoidant point is analyzed. An abnormal point of the machining path is obtained. If the machining path has an abnormal point, the machining program is modified to add an abnormality avoidant path on the avoidant point of the machining path.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1 is a functional block diagram of a machining abnormality avoidant system according to an embodiment of the present disclosure.

FIG. 2 is a flowchart of a path modification method using the machining abnormality avoidant system of FIG. 1.

FIG. 3 is a schematic diagram of a machining path of a machining program of FIG. 1.

FIG. 4 is a relationship diagram of machining depth vs cutter rotation speed according to an embodiment of the present disclosure.

FIG. 5 is a schematic diagram of adding an abnormality avoidant path of the machining path.

FIG. 6 is another flowchart of a path modification method using the machining abnormality avoidant system of FIG. 1.

FIGS. 7A-7C are schematic diagrams of actual machining process using the machining path of FIG. 5.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

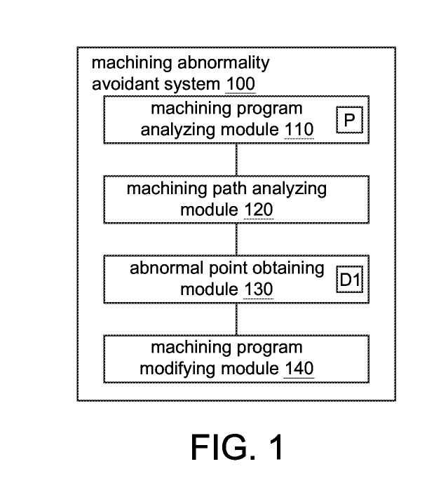

FIG. 1 is a functional block diagram of a machining abnormality avoidant system according to an embodiment of the present disclosure. The machining abnormality avoidant system 100 includes a machining program analyzing module 110, a machining path analyzing module 120, an abnormal point obtaining module 130 and a machining program modifying module 140.

In the present specification, “module” refers to software, firmware or a circuit formed in semiconductor manufacturing process. Besides, at least two of the machining program analyzing module 110, the machining path analyzing module 120, the abnormal point obtaining module 130 and the machining program modifying module 140 can be integrated into one module. The said modules can communicate through wires.

The machining program analyzing module 110 is configured to analyze the machining path P1 of the machining program P. The machining program P is such as a numeric control code (NC code). The machining path analyzing module 120 is configured to analyze whether any point of the machining path P1 is an avoidant point. The abnormal point obtaining module 130 is configured to obtain the abnormal point of the machining path P1. If the machining path P1 has the abnormal point, the machining program modifying module 140 adds an abnormality avoidant path on the avoidant point of the machining path P1.

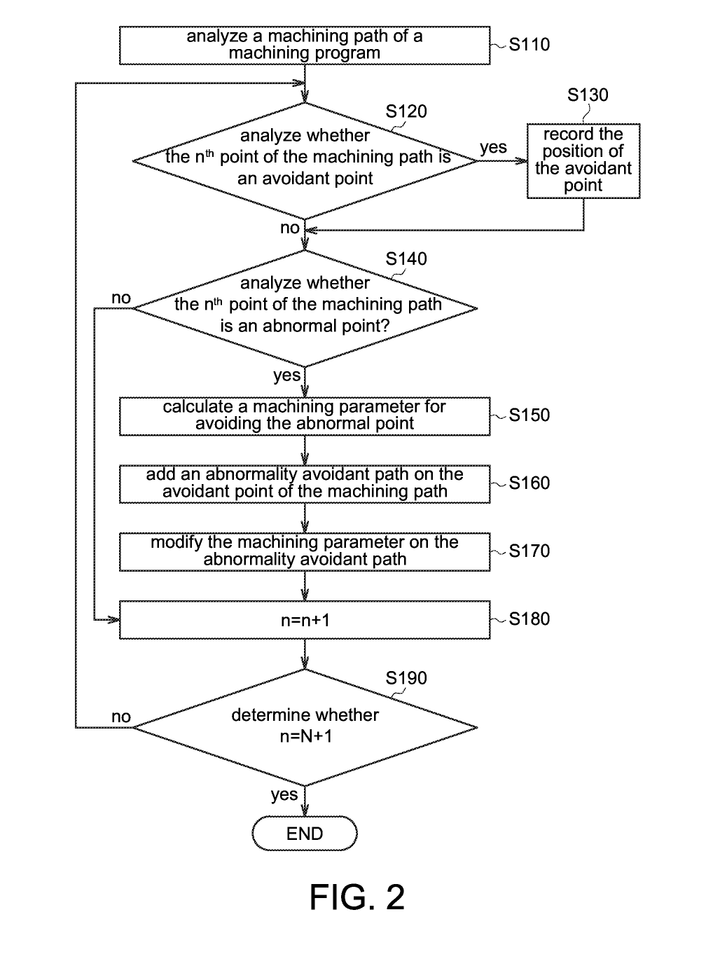

FIG. 2 illustrates how the machining abnormality avoidant system 100 of FIG. 1 modifies the machining path P1 of the machining program P to avoid abnormality during actual machining process.

FIG. 2 is a flowchart of a path modification method using the machining abnormality avoidant system 100 of FIG. 1.

In step S110, the machining program analyzing module 110 analyzes a machining path P1 of a machining program P.

In step S120, the machining path analyzing module 120 analyzes whether any point of the machining path P1 is an avoidant point. If yes, the method proceeds to step S130; if no, the method proceeds to step S140. Here, the avoidant point refers to the position at which collision of mechanical parts will not occur.

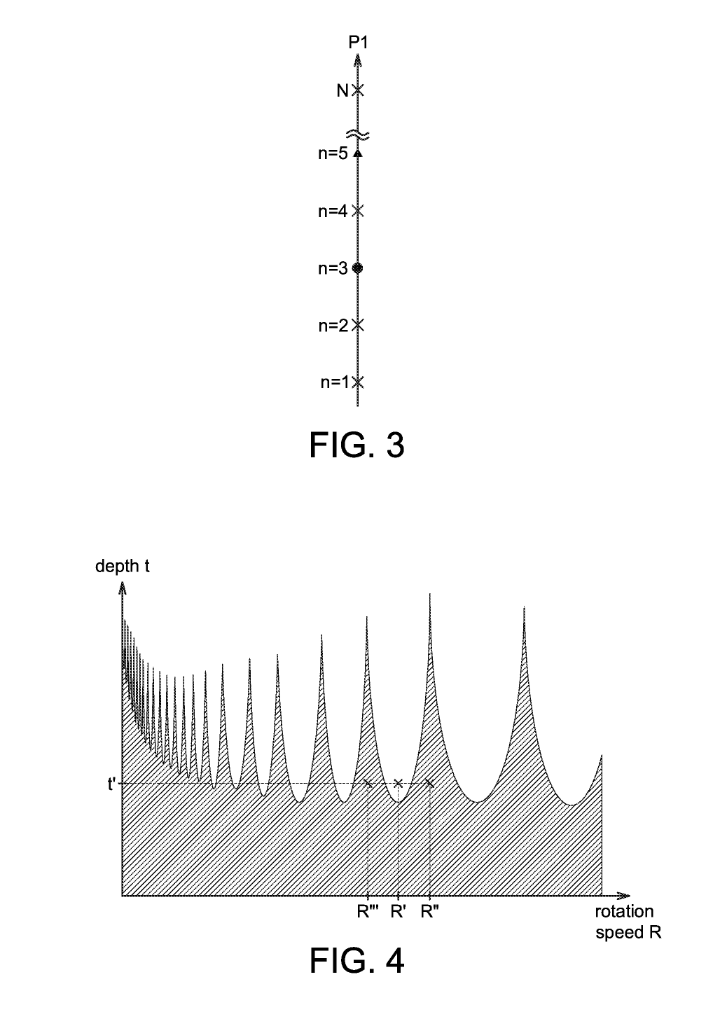

Refer to both FIG. 2 and FIG. 3. FIG. 3 is a schematic diagram of a machining path P1 of a machining program P of FIG. 1. The machining path analyzing module 120 analyzes whether the n^{th} point of the machining path P is an avoidant point, wherein the initial value of n is 1. If the first point is a non-avoidant point, the method proceeds to step S140; if the first point is an avoidant point, the method proceeds to step S130. In step S130, the machining path analyzing module 120 records the position of the first point. Then, the method proceeds to step S140. In the present embodiment of the present disclosure, the first point of the machining path P1 is exemplified by a non-avoidant point. The machining path P1 can be realized by a straight line, a curve or a combination of a straight line and a curve.

The avoidant point can be decided according to the size of the machining cutter, the shape of the workpiece and/or the machining path. For example, if the machining cutter does not interfere or collide with the workpiece or any parts of the machine tool when the machining cutter moves away from a particular point on the workpiece, this particular point can be used as an avoidant point.

In step S140, the abnormal point obtaining module 130 obtains at least one abnormal point of the machining path P1. In the present embodiment, the abnormal point obtaining module 130 analyzes whether the first point (n=1) of the machining path P1 is an abnormal point. If yes, the method proceeds to step S150; if no, the method proceeds to step S180. In the present embodiment, the first point is not an abnormal point. In step S180, the abnormal point obtaining module 130 analyzes whether the next point of the machining path P1, that is, the (n+1)^{th} point, is an abnormal point. In the present specification, the abnormal point is exemplified by any point, such as a chatter point, that may affect the lifespan and/or machining quality of the machining cutter.

Details of the method for analyzing the second point to the fifth point of the machining path P1 are similar to that for analyzing the first point, and the similarities are not repeated here. In the present embodiment of the present disclosure, the avoidant point is exemplified by the third point of the machining path P1. Therefore, in step S130, the machining path analyzing module 120 records the position of the third point, and the abnormal point is exemplified by the fifth point. In another embodiment, the avoidant point is normally positioned before the abnormal point (just like the third point is positioned before the fifth point) or on the same point.

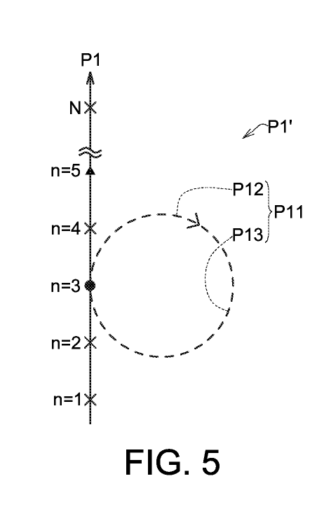

In step S150, the machining program modifying module 140 calculates a machining parameter for avoiding the abnormal point. Referring to FIG. 4, a relationship diagram of machining depth t vs cutter rotation speed R according to an embodiment of the present disclosure is shown. Suppose abnormality occurs at a chatter point. The slashed zone of FIG. 4 is a chatter free zone. Let the fifth point of the machining path P1 (such as the chatter point) be taken for example. The machining depth is t′, and its corresponding cutter rotation speed is R′. Such relationship will occur at the chatter zone. The machining program modifying module 140 can calculate the machining parameter for avoiding abnormality according to FIG. 4 to avoid the chatter zone. Given that the machining depth t′ remains unchanged, the cutter rotation speed can be increased or reduced to R″ or R″′ (the non-chatter zone). In another embodiment, the modified machining parameter can be determined according to the cutting depth, the cutting width and/or the removed volume of the workpiece. In the present embodiment of the present disclosure, the modification of the machining parameter is not subjected to any specific restrictions as long as abnormality can be avoided.

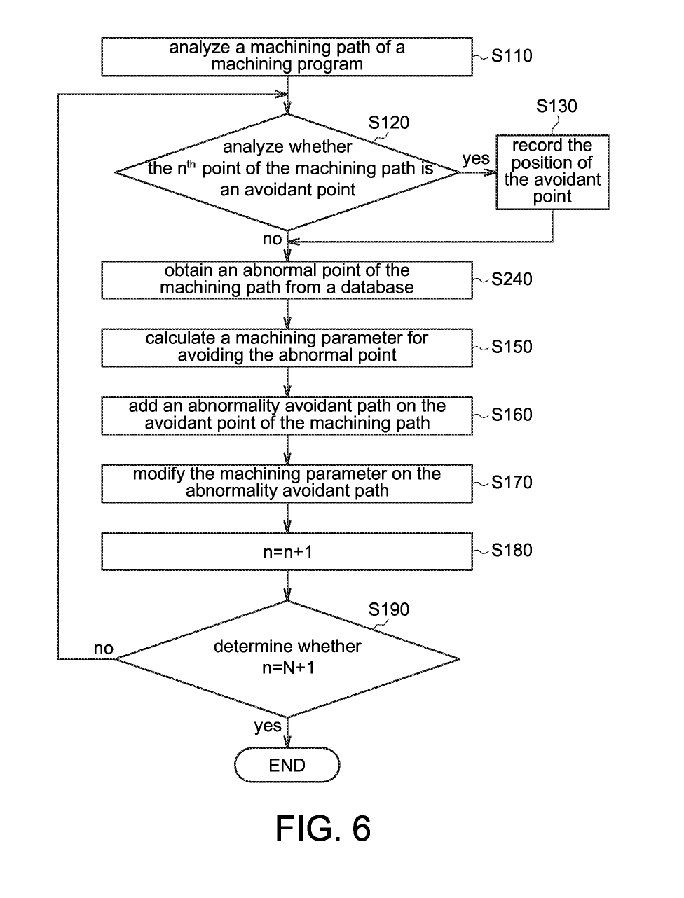

Then, the method proceeds to step S160 and S170. Referring to FIG. 5, a schematic diagram of adding an abnormality avoidant path P11 of the machining path P1 is shown. Since the machining path P1 has the abnormal point (for example, n=5), the machining program modifying module 140 adds an abnormality avoidant path P11 on the avoidant point of the machining path P1 (for example, n=3), and the modified machining path is P1′. When the cutter is on the avoidant point, the cutter can use the original machining parameter for the avoidant point. However, after the cutter enters the abnormality avoidant path P11, the original machining parameter can be adjusted. For example, the cutter rotation speed is changed to R″ or R″′ to avoid abnormality (or the abnormal point). Thus, during actual machining process, the cutter performs machining according to the abnormality avoidant path P11 and the modified machining parameter to avoid abnormality and eliminate the cutting traces caused by abnormality. In the present embodiment, step S170 is performed after step S160, but in another embodiment, step S170 and step S160 can be performed concurrently.

As indicated in FIG. 5, if the abnormal point of the machining path P1 (such as the fifth point) is a non-avoidant point, the machining program modifying module 140 adds an abnormality avoidant path P11 to the avoidant point (such as the third point) closest to the fifth point of the machining path P1 and modifies the original machining parameter, but the present embodiment of the present disclosure is not limited thereto. In another embodiment, if the abnormal point of the machining path P1 is itself an avoidant point or every point on the machining path P1 is an avoidant point, the machining program modifying module 140 adds an abnormality avoidant path P11 to the abnormal point.

The abnormality avoidant path P11 includes an exit path P12 farther away from the avoidant point and an entering path P13 close to the avoidant point. The exit path P12 can be tangent to or can intersect the machining path P1 at the avoidant point. In FIG. 5, the exit path P12 is tangent to the machining path P1. The entering path P13 is tangent to the machining path P11 at the avoidant point and smoothly contacted by the workpiece to avoid the machining surface being damaged and generating traces. In the present embodiment, the abnormality avoidant path P11 is a circular path. However, the abnormality avoidant path P11 can also be realized by an oval path, an arced path or other path composed of a straight line and a curve. The present embodiment of the present disclosure does not specify the geometric shape and/or the size (such as the radius of curvature or avoidant length) of the abnormality avoidant path P11 as long as the abnormality avoidant path P11 does not interfere with the workpiece or the machine tool surrounding the workpiece during the avoidant process.

After step S170 is completed, the method proceeds to step S180. In step S180, the abnormal point obtaining module 130 continues to analyze the next point of the machining path P1, that is, the (n+1)^{th} point.

In step S190, the machining program analyzing module 110 analyzes whether the n^{th} point of the machining path P1 (that is, the (n+1)^{th} point of step S180) is the (N+1)^{th} point, wherein N is the last point of the machining path P1. If the (n+1)^{th} point is the (N+1)^{th} point, this implies that the analysis of all machining points of the machining path P1 has been completed, and the analysis process can be terminated. If the (n+1)^{th} point is not the (N+1)^{th} point, this implies that the analysis of all machining points of the machining path P1 has not been completed, and the method proceeds to step S120 to analyze the next point.

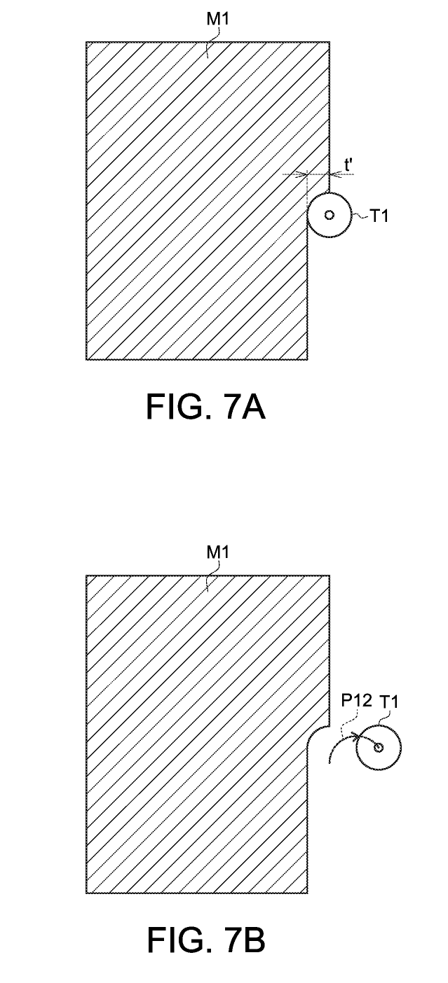

FIG. 6 is another flowchart of a path modification method using the machining abnormality avoidant system 100 of FIG. 1. The present embodiment is different from the previous embodiment in that in step S240, the abnormal point obtaining module 130 can obtain the abnormal point of the machining path P1 from the database D1 (illustrated in FIG. 1). Under such design, the abnormal point obtaining module 130 can dispense with the analysis process. In an embodiment, the abnormal point of the machining path P1 is analyzed by using the technology disclosed in Taiwanese Patent No. 201521954, and then the abnormal point is pre-stored in the database D1.

Other steps of the flowchart of the path modification method of the present embodiment are similar to corresponding steps of the flowchart of the path modification method of FIG. 2, and the similarities are not repeated here.

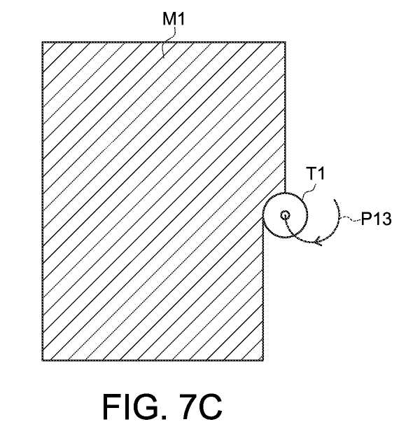

FIGS. 7A-7C are schematic diagrams of actual machining process using the machining path P′ of FIG. 5. The modified machining program of the present embodiment of the present disclosure can be used in milling machines, grinders or computer numeric control machine tool (CNC), but is not limited thereto.

As indicated in FIG. 7A, when the cutter T1 machines to the avoidant point of the modified machining path P1′ (such as the third point), the cutter T1 moves away from the workpiece M1 via the exit path P12 of the abnormality avoidant path P11 as indicated in FIG. 7B. During the process of moving away from the workpiece M1, the cutter T1 changes the machining parameter to avoid abnormality. For example, the cutter T1 can increase or reduce the rotation speed. In the present embodiment of the present disclosure, the cutter T1 does not contact the workpiece M1 during the process of changing the machining parameter, so the cutter T1 can avoid being damaged when cutting condition changes abruptly during the machining process (such as abrupt change in the cutting force) or generating traces on the workpiece M1. Then, as indicated in FIG. 7C, the cutter T1 returns to the workpiece M1 via the entering path P13 of the abnormality avoidant path P11 to contact the workpiece M1 and continue the uncompleted machining process.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A machining abnormality avoidant system, comprising:
a machining program analyzing module configured to analyze a machining path of a machining program;
a machining path analyzing module configured to analyze whether any point of the machining path is an avoidant point;
an abnormal point obtaining module configured to obtain an abnormal point of the machining path; and
a machining program modifying module configured to add an abnormality avoidant path on the avoidant point of the machining path if the machining path has the abnormal point.

2. The machining abnormality avoidant system according to claim 1, wherein the machining program modifying module is further configured to calculate a machining parameter for the abnormal point and modify the machining parameter on the abnormality avoidant path.

3. The machining abnormality avoidant system according to claim 1, wherein the machining path analyzing module is further configured to:
record a position of the avoidant point if the machining path has the avoidant point.

4. The machining abnormality avoidant system according to claim 1, wherein the abnormality avoidant path comprises an exit path away from the avoidant point.

5. The machining abnormality avoidant system according to claim 1, wherein the abnormality avoidant path comprises an entering path close to the avoidant point and tangent to the machining path at the avoidant point.

6. The machining abnormality avoidant system according to claim 1, wherein the abnormal point obtaining module is further configured to:
analyze whether any point of the machining path is the abnormal point.

7. The machining abnormality avoidant system according to claim 1, wherein the abnormal point obtaining module is further configured to:
obtain the abnormal point of the machining path from a database.

8. The machining abnormality avoidant system according to claim 1, wherein the abnormal point is a chatter point.

9. The machining abnormality avoidant system according to claim 1, wherein the abnormality avoidant path is a circular path.

10. The machining abnormality avoidant system according to claim 1, wherein the abnormality avoidant path is a path composed of a straight line and a curve.

11. A machining path modification method, comprising the steps of:
analyzing a machining path of a machining program;
analyzing whether any point of the machining path is an avoidant point;
obtaining at least one abnormal point of the machining path; and
modifying the machining program to add an abnormality avoidant path on the avoidant point of the machining path if the machining path has the abnormal point.

12. The machining path modification method according to claim 11, further comprising:
calculating a machining parameter for the abnormal point and modifying the machining parameter on the abnormality avoidant path.

13. The machining path modification method according to claim 11, further comprising:
recording a position of the avoidant point if the machining path has the avoidant point.

14. The machining path modification method according to claim 11, wherein the abnormality avoidant path comprises an exit path farther away from the avoidant point.

15. The machining path modification method according to claim 11, wherein the abnormality avoidant path comprises an entering path close to the avoidant point and tangent to the machining path at the avoidant point.

16. The machining path modification method according to claim 11, wherein the step of obtaining the abnormal point of the machining path comprises:
analyzing whether any point of the machining path is the abnormal point.

17. The machining path modification method according to claim 11, wherein the step of obtaining the abnormal point of the machining path comprises:
obtaining the abnormal point of the machining path from a database.

18. The machining path modification method according to claim 11, wherein the abnormal point is a chatter point.

19. The machining path modification method according to claim 11, wherein the abnormality avoidant path is a circular path.

20. The machining path modification method according to claim 11, wherein the abnormality avoidant path is a path composed of a straight line and a curve.

21. The machining path modification method according to claim 11, wherein the avoidant point is the same of the abnormal point or before on the the machining path.
